(19) United States
(12) Patent Application Publication
(10) Pub. No.: US 2019/0111617 A1
(43) Pub. Date: Apr. 18, 2019

(54) RESIN POWDER, RESIN MOLDED ARTICLE, AND LASER POWDER MOLDING DEVICE

(71) Applicant: HITACHI, LTD., Tokyo (JP)

(72) Inventors: Satoshi ARAI, Tokyo (JP); Shigeharu TSUNODA, Tokyo (JP)

(73) Assignee: HITACHI, LTD., Tokyo (JP)

(21) Appl. No.: 16/090,541

(22) PCT Filed: Apr. 13, 2016
(86) PCT No.: PCT/JP2016/061858

§ 371 Date: Oct. 1, 2018

(51) Int. Cl. B29C 64/153; B33Y 30/00; B33Y 70/00; B33Y 80/00; B29C 64/218; B29C 64/268

(52) U.S. Cl. CPC B29C 64/153; B33Y 30/00; B33Y 70/00; B29K 2101/12; B29C 64/218; B29C 64/268; B33Y 80/00

(57) ABSTRACT

The invention is to provide a resin powder that is highly robust with regard to temperature control and is capable of improving heat resistance of a molded article. In order to solve the above problem, the resin powder according to the invention uses a mixed resin powder in which a thermoplastic base resin powder and a thermoplastic high-melting-point resin powder having a melting point higher than that of the base resin powder are mixed together. For example, isophthalic acid copolymerized PBT (polybutylene terephthalate) is used in the base resin powder, and homo-PBT is used in the high-melting-point resin powder. Alternatively, a polyamide 12 is used in the base resin powder, and MXD nylon is used in the high-melting-point resin powder.

### TECHNICAL FIELD

The present invention relates to a resin powder, a resin molded article, and a laser power molding device.

### BACKGROUND ART

A powder lamination molding method does not use a mold and thus has a merit that a trial manufacture can be done in a short period of time, and can be used in a trial manufacture for functional confirmation. In addition, the method is not only applicable for the trial manufacture, and the application needs thereof for direct manufacturing various products in small quantities are also increasing. Based on this background, the powder lamination molding method is gaining a great deal of attention in recent years.

As the background art of the technical field, there are for example, Japanese Patent No. 2847579 (PTL 1), JP-A-2011-68125 (PTL 2) and Japanese Patent No. 4913035 (PTL 3).

Japanese Patent No. 2847579 (PTL 1) describes a device for manufacturing a three dimensional object, which includes at least one linear energy radiation heater for changing heating power along a length thereof.

JP-A-2011-68125 (PTL 2) describes a molded product, which is formed by impregnating a heat-resistant resin into a molding body prepared by a powder sintering lamination molding method using a composite material powder with a spherical carbon and a resin powder as essential components.

Japanese Patent No. 4913035 (PTL 3) describes a powder which includes a first fraction present in a form of a spherical powder particle substantially and formed by a matrix material, and preferably at least another fraction in a form of a strengthening and/or reinforcing fiber embedded in the matrix material.

### PRIOR ART LITERATURE

### Patent Literature

PTL 1: Japanese Patent No. 2847579

PTL 2: JP-A-2011-68125

PTL 3: Japanese Patent No. 4913035

### SUMMARY OF INVENTION

### Technical Problem

In the powder lamination molding method, in order to prevent a warp of a molded article in molding, a surface temperature of the resin powder and a temperature of the molded article immediately before sintering need to be set between a melting point and a crystallization temperature of the resin powder by a heating unit provided in a molding portion and the like. However, since the temperature control is difficult, problems such as melting of the resin powder in a part other than a molded part, welding of adjacent molded parts, and a failure of releasing the molded article from the resin powder may occur. A resin powder is desired, which has a high robustness to the temperature control and can improve heat resistance of the molded article.

### Solution to Problem

In order to solve the above problems, a resin powder according to the invention is a mixed resin powder, including a thermoplastic first resin material having a first melting point, and a thermoplastic second resin material having a second melting point higher than the first melting point.

In addition, a resin molded article according to the invention includes a sintered portion formed by powder lamination molding using a mixed resin powder, the mixed resin powder including a thermoplastic first resin material having a first melting point, and a thermoplastic second resin material having a second melting point higher than the first melting point.

In addition, a laser powder molding device according to the invention includes a roller for laying resin powders, and a laser light source for irradiating a laser light to the laid resin powders. The resin molded article is molded by: a first step of sequentially repeating laying the resin powders by the roller and irradiating the laser light to the laid resin powders with a first energy, and after the first step, a second step of sequentially repeating laying the resin powders by the roller and irradiating the laser light to the laid resin powders with a second energy which is different from the first energy.

### Advantageous Effect

According to the invention, a resin powder can be provided, which has a high robustness to temperature control, and can improve heat resistance of a molded article.

A problem, configuration and effect other than those above mentioned will be clarified by the description of the following embodiments.

### BRIEF DESCRIPTION OF DRAWINGS

FIG. 1 is a schematic diagram illustrating a configuration of a laser powder lamination molding device according to an embodiment.

FIG. 2 is a pattern diagram illustrating an example of a mixed resin powder according to an embodiment.

FIG. 3 is a pattern diagram illustrating another example of the mixed resin powder according to the embodiment.

FIG. 4 is a flow chart illustrating an example of a laser powder lamination molding method according to an embodiment.

FIG. 5 is a cross-sectional view illustrating an example of a molded article molded by using the laser powder lamination molding method according to the embodiment.

FIG. 6 is a flow chart illustrating another example of the laser powder lamination molding method according to the embodiment.

FIG. 7 is a cross-sectional view illustrating another example of a molded article molded by using the laser powder lamination molding method according to the embodiment.

### DESCRIPTION OF EMBODIMENTS

Hereinafter, embodiments of the invention will be described based on the drawings. In all the drawings for explaining the embodiments, in principle, the same members are denoted by the same reference numerals, and repetitive descriptions thereof are omitted.

In the following embodiments, the description may be divided into a plurality of sections or embodiments if necessary for convenience. However, unless specifically indicated, these embodiments are not independent with each other, but are in a relationship in which one is a modification, an application example, a detailed description, a supplementary description, and the like of a part or all of the other. Further, in the following embodiments, in a case where a number and the like (including a number, a numeric value, an amount, a range and the like) of an element are mentioned, the number is not limited to specific numbers, and may be greater or less than the specific numbers, unless specifically indicated or unless the number is clearly limited to the specific numbers in principle.

Further, in the following embodiments, constituent elements thereof (including elements step and the like) are not absolutely essential unless specifically indicated or unless clearly considered to be essential in principle. Similarly, in the following embodiments, when shapes, positional relations, etc. of the constituent elements and the like are mentioned, substantially approximate and similar shapes, etc. are included, unless specifically indicated or clearly excluded in principle. The same also applies to the numeric value (including a number, a numeric value, an amount, a range and the like) described above.

Hereinafter, the embodiments will be described based on the drawings. Further, in all the drawings for explaining the embodiments, in principle, the members having the same function are denoted by the same or related reference numerals, and repetitive descriptions thereof are omitted. In addition, in a case of a plurality of similar members (parts), a symbol may be added to a sign of a generic name to indicate a separate or a specific part. In addition, in the following embodiments, unless particularly necessary, the description of the same or similar portion is not repeated in principle.

In addition, in a cross-sectional view and a plan view, a magnitude of each part does not correspond to an actual device, and the specified portion may be showed relatively larger for easily understanding of the drawings. In addition, even in a case where the cross-sectional view and the plan view correspond to each other, the specified portion may be showed relatively larger for easily understanding of the drawings.

### Embodiments

### (Regarding Laser Powder Lamination Molding Device)

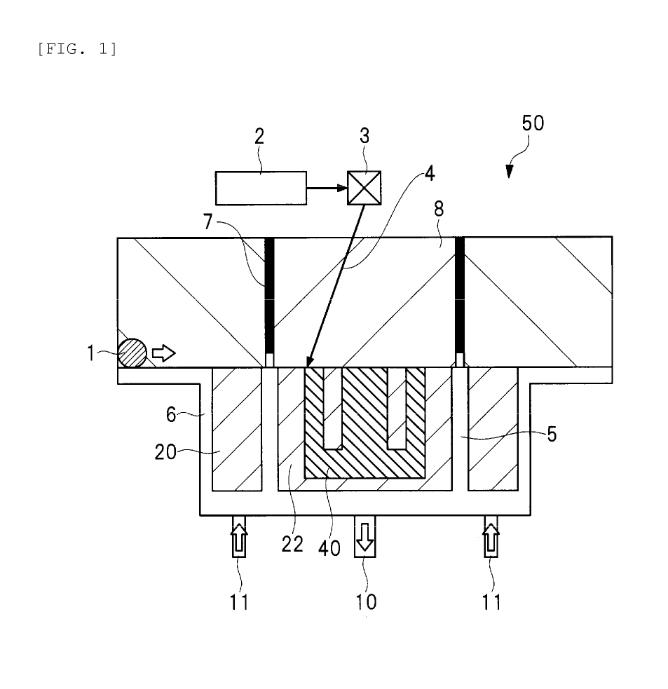

Hereinafter, a laser powder lamination molding device according to the present embodiment will be described using FIG. 1. FIG. 1 is a schematic diagram illustrating a configuration of the laser powder lamination molding device according to the present embodiment.

The laser powder lamination molding device 50 includes a roller (or blade) 1 for supplying a resin powder 20 for supply to a molding area 8, a laser light source 2 for sintering or melting a resin powder 22 disposed in the molding area 8 and for lamination bonding, and a galvanometer mirror 3 for moving a laser light 4 in a high speed in the molding area 8.

Further, the laser powder lamination molding device 50 includes a molding container 5 of the molding area 8, a reflecting plate 7, a storage container 6 disposed at both sides of the molding container 5 and for storing the resin powder 20, pistons 10 and 11 for operating the molding container 5 and the storage container 6 in an upper-lower direction, and a heater (not shown). The molding area 8, the molding container 5 and the storage container 6 can be kept at a high temperature by the heater. Further, the configuration and structure of the heater may be properly changed.

In addition, an area temperature of the storage container 6 for storing the resin powder 20 may be lower than or equal to a temperature of the molding area 8.

In powder lamination molding, a resin molded article 40 is prepared three-dimensionally by laying resin powders 22 by the roller (or blade) 1, sintering or melting the resin powder 22 disposed in the molding area 8 by the laser light 4, and repeating the above. A lamination thickness of the resin powders 22 laid by the roller (or blade) 1 is at least 150 μm or less since thermal decomposition occurs when the thickness is too thick.

After repeating the powder lamination molding, the resin molded article 40 is in a state of being embedded in the resin powder 22. The resin molded article 40 is taken out from the resin powder 22, and thereafter the resin powder 22 is peeled off from the resin molded article 40 by blast treatment and the like.

In order to inhibit degradation of the resin powder 22, it is desirable to purge the molding area 8 with nitrogen or argon to lower a concentration of oxygen.

In addition, it is necessary to change the laser light source 2 according to an absorption property of the resin powder 22, and a CO₂ laser (having a wavelength of 10.6 μm) is used in a case of using the resin powder 22 of a natural color. In a case of using the resin powder 22, such as one of black color, containing a material absorbing infrared lights, not only the CO₂ laser, a fiber laser, a YAG laser or a semiconductor laser (having a wavelength of 800 nm to 1,100 nm) may be used.

An intensity distribution of the laser light 4 is usually a Gaussian distribution, and a top hat shape can achieve laser irradiation with high definition. From a viewpoint of precision, it is preferable to reduce a spot size of the laser light 4, but the time for molding is prolonged accordingly. Therefore, a spot size of 100 μm or more and 600 μm or less is used for the laser light 4.

A 3DCAD model disposed in the laser powder lamination molding device 50 in advance is used in the powder lamination molding. Operational procedures such as irradiate conditions of laser irradiation (such as a laser power, a speed, a laser pitch, an irradiate direction and an irradiate number) and the like are set for each layer based on the 3DCAD model.

This setting may be performed by a computer (not shown) including the laser powder lamination molding device 50 or a computer connected via a separate network or the like, and may be in any mode. Information on this 3DCAD model or the set operational procedures is saved in a storage unit of the laser powder lamination molding device 50, and the saved information is used for performing the powder lamination molding.

The information on the operational procedures and the like may be input by transmitting to and receiving from the storage unit of the laser powder lamination molding device 50 by, for example, means using communication such as a network from another computer or means using a storage device such as an optical disk such as a CD-ROM, or a flash memory.

### (Regarding Material of Resin Powder)

In a case of performing the powder lamination molding, in order to ensure a high molding quality (particularly density) and inhibit a warp of the molded article in molding, the molding area where the resin powder and the molded article are disposed need to set to a temperature not reaching a melting point of the resin powder, and a temperature higher than a crystallization temperature of the resin powder.

In fact, the molding area is set to a temperature region where a part of the resin powder starts to melt. This is for avoiding problems that the molded article is warped after the irradiation of the laser light, the molded article is moved by the roller and cannot be molded, or sufficient strength cannot be obtained even if the molded article can be molded, and the like.

Therefore, the temperature of the molding area is adjusted by 0.5° C. unit. However, for example, when the temperature of a part of the molding area rises by several Celsius degrees, resin powders may melt and may be welded. In addition, since the above temperature region is set, a problem may also occur that when the molded article after molding is taken out, a portion other than the portion irradiated by the laser light will be adhered thereto, and unnecessary portions cannot be removed easily even by the blast treatment.

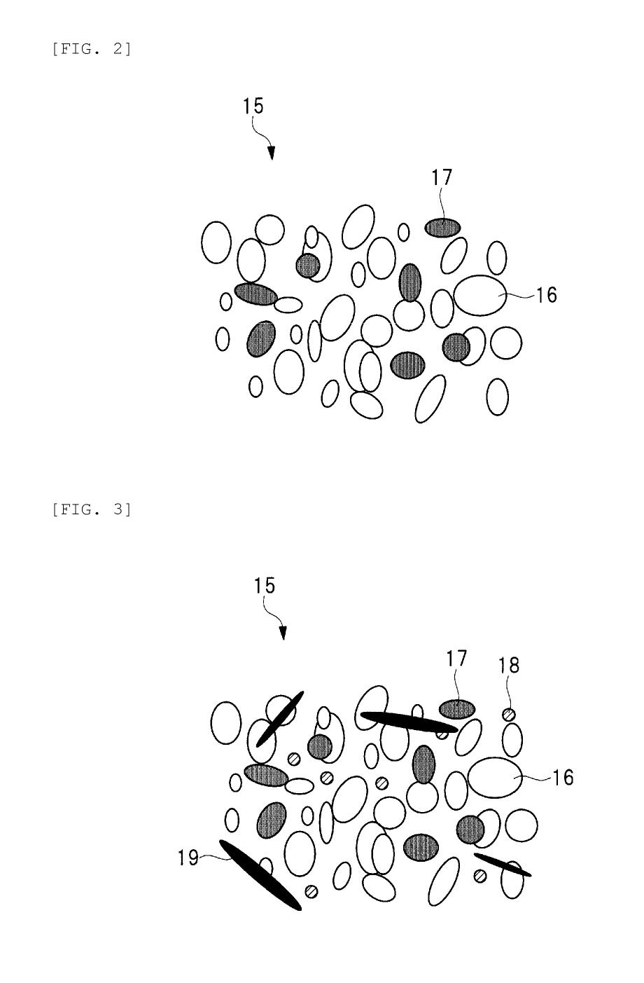

In view of this problem, the present inventors have discussed to use a mixed resin powder 15 in which a high-melting-point resin powder 17 having a melting point higher than a melting point of a base resin powder 16 is mixed with the base resin powder 16, as shown in FIG. 2. As a result, it has been found that the peeling of the portion irradiated by the laser light and the portion not irradiated by the laser light becomes easy by (1) realizing the molding, (2) making the portion irradiated by the laser light and the portion not irradiated by the laser light less adhered, and (3) the blast treatment.

Here, the result of the discussion performed by the present inventors will be described in detail.

### FIRST EXAMPLE

### (Resin Powder Using Polyester as Base Resin)

As the first Example, a mixed resin powder 15 is described, in which thermoplastic isophthalic acid copolymerized PBT (polybutylene terephthalate) is used in the base resin powder 16, and thermoplastic homo-PBT is used in the high-melting-point resin powder 17.

First, two kinds of pellets of the isophthalic acid copolymerized PBT (10 mol %) and the homo-PBT were prepared (the pellet of the isophthalic acid copolymerized PBT has a melting point of 208° C. and a crystallization temperature of 153° C., and the pellet of the homo-PBT has a melting point of 225° C. and a crystallization temperature of 180° C.).

Then, while being cooled with liquid nitrogen by Contraplex 400 CW manufactured by Makino mfg. co. ltd, each of the two kinds of pellets was crushed and micro-pulverized at a low temperature.

Then, each of the two kinds of powders was passed through a mesh comb with a mesh size of 106 μm specified by JISZ8801-2000 with an air jet sieve manufactured by Alpine Electronics, Inc., and the powders were 95% or more. At that time, a central particle diameter of the isophthalic acid copolymerized PBT powder was 80 μm, and a central particle diameter of the homo-PBT powder was 76 μm.

As a result of performing a Differential Scanning calorimetry (DSC) for the two kinds of powders, it was understood that the crystallization temperature of the isophthalic acid copolymerized PBT powder was 170° C., the crystallization temperature of the homo-PBT powder was 195° C., and the crystallization temperature in a powder state rises compared to the crystallization temperature in a pellet state. Meanwhile, no variation in melting point was observed in the pellet state and the powder state.

Then, a first resin powder was prepared in which a fumed silica having an average primary particle diameter of 12 nm was added to the isophthalic acid copolymerized PBT powder by 0.1 wt % based on the isophthalic acid copolymerized PBT powder, and a second resin powder was prepared in which a fumed silica having an average primary particle diameter of 12 nm was added to the homo-PBT powder by 0.1 wt % based on the homo-PBT powder. Further, a blend material was also prepared in which the first resin powder and the second resin powder were blended. At that time, the first resin powder and the second resin powder were blended such that a weight ratio of the homo-PBT to the isophthalic acid copolymerized PBT was 10%, 30%, or 60%.

Thereafter, an assessment of the molding using the blend material was performed. RaFaEl 300 manufactured by Aspect inc. was used in the laser powder lamination molding device. The molding conditions and the molding results at that time are shown in Table 1. The temperature of the molding area for molding was 190° C. where the isophthalic acid copolymerized PBT can be molded.

TABLE 1

| | | No. | | | | |
|---|---|---|---|---|---|---|
| | | 1 | 2 | 3 | 4 | 5 |
| Proportion(%) of isophthalic acid | | 100 | 90 | 70 | 40 | 0 |
| copolymerized PBT powder(having | | | | | | |
| average particle size of 80 μm) | | | | | | |
| Proportion (%) of homo-PBT | | 0 | 10 | 30 | 60 | 100 |
| powder (having average particle size | | | | | | |
| of 76 μm) | | | | | | |
| Molding | Laser power (W) | 14 | 14 | 14 | 14 | 14 |
| conditions | Scan speed (m/s) | 5.0 | 5.0 | 5.0 | 5.0 | 5.0 |
| | Scan pitch (mm) | 0.15 | 0.15 | 0.15 | 0.15 | 0.15 |
| | Lamination thickness (mm) | 0.10 | 0.10 | 0.10 | 0.10 | 0.10 |
| | Retaining temperature of | 190 | 190 | 190 | 190 | 190 |
| | molding area (° C.) | | | | | |
| | Retaining temperature of | 175 | 175 | 175 | 175 | 175 |
| | storage area (° C.) | | | | | |
| Molding | Can be molded or not | Yes | Yes | Yes | No | No |
| assessment | Bending strength (MPa) | 72 | 68 | 65 | — | — |

As a result, the blend materials in which the weight ratios of the homo-PBT to the isophthalic acid copolymerized PBT were 10% and 30% can be molded into molded articles. In contrast, the blend material in which the weight ratio of the homo-PBT to the isophthalic acid copolymerized PBT was 60% cannot be molded since the molded article was warped after the irradiation of the laser light and the molded article was moved by the roller.

In addition, in a case of molding with the blend materials in which the weight ratio of the homo-PBT to the isophthalic acid copolymerized PBT were 10% and 30%, when the molded article was taken out, an adhesive force between the resin powders was also obviously small, and the portion other than the molded portion can be removed easily by the blast treatment, compared to a case of molding only with the isophthalic acid copolymerized PBT.

In addition, a bending strength in a case of molding only with the isophthalic acid copolymerized PBT was 72 MPa, while a bending strength in a case of molding with the blend material in which the weight ratio of the homo-PBT to the isophthalic acid copolymerized PBT was 10% was 68 MPa, and a bending strength in a case of molding with the blend material in which the weight ratio was 30% was 65 MPa, so that a high bending strength can be ensured.

In the present embodiment, examples of the copolymerized PBT as the base resin include a copolymer of terephthalic acid and 1,4-butanediol, and a copolymer of the above and other copolymerizable dicarboxylic acids (or an ester-forming derivative thereof) or other diols (or an ester-forming derivative thereof).

As the above other dicarboxylic acids, isophthalic acid, phthalic acid, 4,4′-diphenyl ether dicarboxylic acid, 5-sodium sulfoisophthalic acid, 2,6-naphthalenecarboxylic acid, azelaic acid, adipic acid, sebacic acid, 1,3-cyclohexanedicarboxylic acid, 1,4-cyclohexanedicarboxylic acid or dimer acids can be used.

In addition, as the above other dials, diethylene glycol, polyethylene glycol, polypropylene glycol or polytetramethylene glycol can be used.

If a copolymerization component, i.e., a proportion of a copolymerization monomer is too much, deterioration in heat resistance becomes prominent. Therefore, the proportion of the copolymerization monomer is desirably 3 mol % or more and 30 mol % or less. Particularly, in a case of the isophthalic acid copolymerized PBT, the proportion of the copolymerization monomer is preferably 5 mol % or more and 15 mol % or less. Considering the proportion of the copolymerization monomer of these, the melting point of the copolymerized PBT is lowered by about 10° C. to 25° C., and is preferably 200° C. or higher, and 215° C. or lower.

In addition, an intrinsic viscosity of the copolymerized PBT is desirably 0.5 dl/g or more and 1.5 dl/g or less. When the intrinsic viscosity is lower than 0.5 dl/g, the mechanical strength of the molded article is low, and when the intrinsic viscosity is more than 1.5 dl/g, a non-sintered portion occurs easily when being irradiated by the laser light, and the mechanical strength of the molded article is lowered.

Since the resin powder is made by the blend material in which the homo-PBT is mixed with the isophthalic acid copolymerized PBT, the molding can be made by commercially available equipment, and the molded article with a high quality can be obtained by lowering the melting point properly.

In addition, the resin powder to be blended is a resin powder having a melting point higher than that of the copolymerized PBT as the base resin. Further, when the adhesion between the resin powders to be mixed is low, a problem occurs that the strength of the molded article is significantly lowered.

Thus, in the present embodiment, as the resin powder to be blended, a resin powder having a primary structure whose compatibility is highly similar to that of the base resin powder 16 becomes a candidate, and in a case where the base resin powder 16 is the copolymerized PBT, other crystalline polyester becomes a candidate.

Specifically, the resin powder to be blended is homo-PBT, PET (polyethylene terephthalate), PTT (polytrimethylene terephthalate), PCT (poly cyclohexylene dimethylene terephthalate), PEN (polyethylene naphthalate), PBN (polybutylene naphthalate) or a liquid crystal polymer, which have a melting point of 223° C. or higher. In any case, the resin powder to be blended may be a copolymer which lowers the crystallization temperature moderately.

### SECOND EXAMPLE

### (Resin Powder Using Polyamide as Base Resin)

As the second embodiment, a mixed resin powder 15 is described, in which a thermoplastic polyamide is used in the base resin powder 16 instead of using the copolymerized PBT in the base resin, and the thermoplastic polyamide is also used in the high-melting-point resin powder 17.

First, for the polyamide as the base resin, polyamide 12 (PA12) having a melting point of 180° C. and a crystallization temperature of 147° C. was prepared, for example, ASPEX-PA (having a central particle diameter of 51 μm) manufactured by Aspect inc.

For the resin powder to be blended, polyamide (MXD nylon) using metaxylene diamine having two melting points (236° C. and 262° C.) was prepared.

Then, a pellet of the PA12 and a pellet of the MXD nylon were crushed separately. The crushed MXD nylon powder had a crystallization temperature of 207° C., and a central particle diameter of 49 μm.

Then, a first resin powder was prepared in which a fumed silica was added to the PA12 powder, and a second resin powder was prepared in which a fumed silica was added to the MXD nylon powder. Further, a blend material was prepared in which the first resin powder and the second resin powder were blended.

Thereafter, an assessment of the molding using the blend material was performed. The molding conditions and the molding results at that time are shown in Table 2. In the blend materials, weight ratios of the MXD nylon to the PA12 were 10%, 30% and 60%, and the temperature of the molding area for molding was 170° C. where the PA12 can be molded.

TABLE 2

| | | No. | | | | |
|---|---|---|---|---|---|---|
| | | 1 | 2 | 3 | 4 | 5 |
| Proportion (%) of PA12 powder(having | | 100 | 90 | 70 | 40 | 0 |
| average particle diameter of 51 μm) | | | | | | |
| Proportion (%) of MXD nylon | | 0 | 10 | 30 | 60 | 100 |
| powder (having average particle | | | | | | |
| diameter of 49 μm) | | | | | | |
| Molding | Laser power (W) | 20 | 20 | 20 | 20 | 20 |
| conditions | Scan speed (m/s) | 5.0 | 5.0 | 5.0 | 5.0 | 5.0 |
| | Scan pitch (mm) | 0.15 | 0.15 | 0.15 | 0.15 | 0.15 |
| | Lamination thickness (mm) | 0.10 | 0.10 | 0.10 | 0.10 | 0.10 |
| | Retaining temperature of | 168 | 168 | 168 | 168 | 168 |
| | molding area (° C.) | | | | | |
| | Retaining temperature of | 150 | 150 | 150 | 150 | 150 |
| | storage area (° C.) | | | | | |
| Molding | Can be molded or not | Yes | Yes | Yes | No | No |
| assessment | Bending strength (MPa) | 61 | 62 | 60 | — | — |

As a result, the blend materials in which the weight ratios of the MXD nylon to the PA12 were 10% and 30% can be molded into molded articles. In contrast, the blend material in which the weight ratio of the MXD nylon to the PA12 was 60% cannot be molded, since the molded article was warped.

In addition, in a case of molding with the blend materials in which the weight ratios of the MXD nylon to the PA12 were 10% and 30%, when the molded article was taken out, an adhesive force between the resin powders was also obviously small, and the portion other than the molded portion can be removed easily by the blast treatment, compared to a case of molding only with the PA12.

In addition, a bending strength in a case of molding only with the PA12 was 61 MPa, while a bending strength in a case of molding with the blend material in which the weight ratio of the MXD nylon to the PA12 was 10% was 62 MPa, and a bending strength in a case where of molding the blend material in which the weight ratio was 30% was 60 MPa, so that a bending strength of the same level can be maintained even with the blend materials.

In the present embodiment, the polyamide as the base resin is a resin powder having a melting point of 215° C. or lower, such as PA12, PA11 or PA6/66 copolymerization. In addition, the resin powder to be blended is a polyamide having a melting point higher than that of the polyamide as the base resin. Examples thereof include PA6 (polyamide 6), PA6-6 (polyamide 6-6), PA4-6 (polyamide 4-6), PA6-10 (polyamide 6-10), PA6-12 (polyamide 6-12), PA6T (polyamide 6T, T indicating terephthalic acid), PA9T (polyamide 9T) or PA-MXD6 (polyamide-MXD6, MXD indicating a component derived from metaxylene diamine). In any case, the resin powder to be blended may be a copolymer which lowers the crystallization temperature moderately.

### (Regarding Mixing Proportion)

As described above, in the present embodiment, a mixed resin powder 15 was used, in which a polyester or polyamide was used as the base resin powder 16, and the high-melting-point resin powder 17 having a primary structure similar to the above and having a melting point higher than the melting point of the base resin powder 16 was mixed with the base resin powder 16. Accordingly, the molding of the base resin powder 16 was achieved at the molding temperature, and the adhesive force of the mixed resin powder 15 other than the molded portion can be lowered.

However, since the mixed resin powder 15 according to the present embodiment contains the high-melting-point resin powder 17 having a higher melting point, when the amount thereof is too much, the molded article is warped in the molding and cannot be molded. Specifically, in the case of powder lamination molding, the irradiation time of laser light for preparing the molded article costs the most time, which depends on the molding area. Particularly, when the irradiation time of laser light for each layer is long, the portion initially irradiated by the laser light is warped.

Therefore, when considering molding an article with a molding area of at least 100 mm or more, in setting the temperature of the molding area determined based on the melting point of the base resin powder 16, it is necessary that the semi-crystallization time of the mixed resin powder 15 is set to 500 seconds or more, or the crystallization starting time is set to be 300 seconds or more. Characteristics of the crystalization can be calculated by isothermal crystallization DSC measurement.

In addition, since the temperature of the molding area of the laser powder lamination molding device is usually about 200° C., even with the above time, it is desirable that the temperature of the molding area is 200° C. or lower.

In addition, considering the warp of the molded article and the strength of the molded article, it is preferable to determine the mixing proportion of resin powders having different melting points from each other. Specifically, for the mixing proportion of the base resin power 16 and the high-melting-point resin powder 17, the proportion of the high-melting-point resin powder 17 to the base resin power 16 is preferably 5% or more and 45% or less, and more preferably 10% or more and 30% or less, in weight ratio.

In addition, in the case of the powder lamination molding, it is usually to mix a certain amount of a virgin material with a cycle material used at one time, so as to perform the molding. In the present embodiment, since the proportion of the virgin material is reduced, the amount of deterioration is also lowered, and recyclability is also improved significantly. In addition, since the adhesive force of the resin powders is lowered, a sieving time for obtaining the recycle material can also be reduced significantly.

### (Regarding Powder Size)

In the case of the powder lamination molding, a surface roughness of the molded article is greatly influenced by the particle size of the resin powder. Therefore, the smaller the particle size is, the lower the surface roughness of the molded article can be. However, since flowability of the resin powder deteriorates when the particle size is reduced, the resin powders cannot be laid uniformly in a region of the molding area by the roller.

Further, in the present embodiment, since the molding temperature is set near the melting point of the base resin powder 16, a part of the base resin powder 16 is in a molten state, and the smaller the particle size is, the more significant the deterioration of the flowability is.

Meanwhile, high-melting-point resin powders 17 having a high melting point can be in an easily laid state since the high-melting-point resin powders 17 do not melt in the molding temperature even if the particle size is small. Therefore, it is desirable that the particle size of the high-melting-point resin powder 17 having a high melting point is smaller than the particle size of the base resin powder 16. Accordingly, there is a merit that the surface roughness of the molded article can be decreased.

Further, in a case where two kinds of resin powders are mixed, an interface of the two kinds of resin powders is welded by the irradiation of the laser light, while in the present embodiment, from the viewpoint of the warp of the molded article in molding, the process condition is based on the melting point of the base resin powder 16. In contrast, in a case where two kinds of resin powders having greatly different melting points from each other are mixed, it may be difficult to ensure the adhesion by sufficient melting of the two kinds of resin powders and to inhibit the thermal decomposition of the resin powder having a low melting point at the same time.

However, also in such a case, since the particle size of the high-melting-point resin powder 17 is small, ensuring the adhesion and inhibiting the thermal decomposition at the same time are easier. In addition, since the mixed resin powder 15 also contains the high-melting-point resin powder 17, the heat resistance at an initial period and in a long period can be improved. Therefore, in a case where the molded article is used in a resin mold, the mixed resin powder 15 can also be developed into a jig and the like used in a reflow step.

The particle size of the base resin powder 16 is desirably 50 μm or more and 150 μm or less, and the particle size of the high-melting-point resin powder 17 is desirably 25 μm or more and 100 μm or less.

### (Regarding Lubricant)

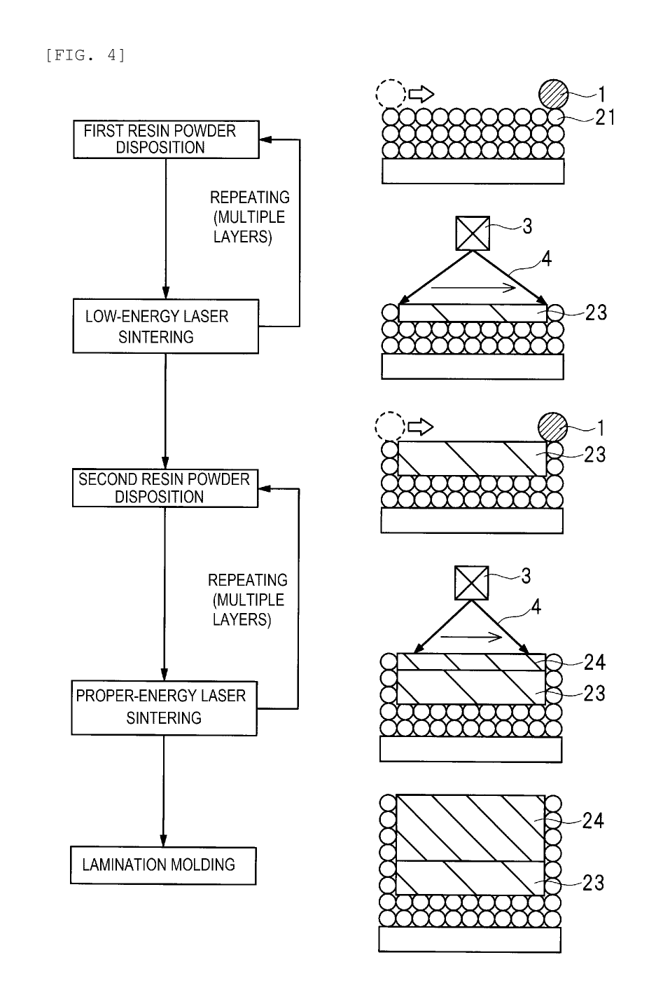

As shown in FIG. 3, in order to improve the flowability, a lubricant 18 may be added to the mixed resin powder 15. Examples of the lubricant 18 can include an inorganic substance such as a fumed silica or alumina. An average primary particle diameter of the lubricant 18 is desirably 100 nm or less. Further, it is desirable that the lubricant 18 is mixed with the resin powder by a mixer, in a state of being aggregated with at least 50% average particle diameter of 100 μm or less.

As a standard for the flowability at a room temperature when the lubricant 18 is added to the mixed resin powder 15, it is desirable that a Hausner ratio calculated from the tap density or bulk density of the resin powder is 1.60 or less, a condensation degree is 40° or less, or an angle of repose is 50° or less. However, when the roughness of the molded article, a molding yield and the strength of the molded article are considered, it is desirable that the Hausner ratio is 1.34 or less, the condensation degree is 25° or less, or the angle of repose is 40° or less.

It is desirable that the amount of the lubricant 18 to be mixed is 0.05% or more and 1% or less with respect to the mixed resin powder 15, in weight ratio. When the amount is more than 1%, an effect of working as a core material is increased, and the molded article is warped after the irradiation of the laser light. In addition, considering those mentioned above, the lamination thickness when using the mixed resin powder 15 is preferably 0.05 mm or more and 0.15 mm or less.

### (Regarding Pulverization)

Examples of the pulverization from pellets to powders include many methods such as a turbo mill, a pin mill or a hammer mill, and a high-speed rotation mill pulverizing by an impacting and shearing action is preferably used. In some cases, a jet mill may be used. Particularly, performing the above at a low-temperature state is advantageous from a viewpoint of cost.

In addition, a method of kneading pellets and a solvent or the like and then cooling and precipitating the same to take out powders may be used. In this case, it is necessary to perform drying since the strength of the molded article cannot be ensured when the solvent is volatilized at one time. However, there are merits that the particle size can be reduced, and the distribution of the particle size is easily made uniform.

In a case where the prescribed micro-pulverization cannot be performed at one time, coarse pulverization may be performed at one time and then the micro-pulverization may be performed, or the micro-pulverization step may be performed several times. In addition, a fine powder may be prepared at a polymerization stage.

### (Regarding Additive)

The mixed resin powder 15 may contain a thermoplastic elastomer. As for the thermoplastic elastomer, a styrene-based elastomer, an olefin-based elastomer, or a polyester-based elastomer is preferable, and the thermoplastic elastomer may be used together with the above-mentioned resin powder.

In addition, a variety of additives may be added to the mixed resin powder 15, for example, an antioxidant, an ultraviolet absorber, a heat stabilizer, a parting agent, an antistatic agent, a colorant such as a dye or pigment, a dispersant or a plasticizer.

In a case of containing the above additives, it is desirably that the additives are added in the stage of the preparing of the pellets, and thereafter are preferably crushed. When the additive is added, the crystallization temperature often rises. In this case, as described above, it is preferable to control the crystallization temperature by increasing a copolymerization ratio or the like. As for the standard, it is desirable that a ratio of the additive to the mixed resin powder 15 is 1 wt % or less.

In addition, in a case where flame retardance such as UL94V-0 is required, it is necessary to contain a flame retardant in an amount more than other additives. Particularly, from a viewpoint of halogen-free, a phosphate ester compound and a hydrated metal compound (aluminum hydroxide or magnesium hydroxide and the like) are preferably used as the flame retardant.

In a case where there is no requirement of halogen-free, from viewpoints of the cost, thermal stability and molding quality, it is preferable to use a material, obtained by adding a flame retardant aid such as antimony to a brominated retardant material, as the flame retardant. As the brominated retardant material, brominated polystyrene, brominated phenoxy, brominated epoxy and the like are effective. Particularly, when brominated epoxy having a relatively high decomposition temperature is used, recycling is also possible and is more effective.

Further, when the UL94V-0 is satisfied, it is necessary that a total of the flame retardant and the flame retardant aid is 10 wt % to 20 wt % to the resin powder. In addition, since the control of the crystallization temperature is necessary as with other additives at that time, it is desirable to crush pellets kneaded with the flame retardant rather than to blend powders of the flame retardant into the resin powder, when considering that the amount of the flame retardant is increased.

As shown in FIG. 3, in order to decrease of a contraction percentage of the mixed resin powder 15, and to improve the rigidity and the heat resistance, it is preferable to add 5 wt % or more and 40 wt % or less of an inorganic filler 19.

In this case, it is preferable to compound inorganic substances (short fiber material) having a size in a long axis direction of 200 μm or less. When the size is larger than the above value, the surface roughness of the molded article is increased, and deterioration in precision of an end part of the molded article becomes prominent. In addition, it is desirable that the inorganic filler 19 with a spherical particle shape may be used, and 50% average particle diameter thereof is 100 μm or less.

In any case, when considering the recyclability and precision, it is necessary to make the powders passing a mesh comb with a mesh size of 106 μm to be 100%.

However, in this case, it is necessary to set at least 99% or more of the inorganic filler 19 to have a largest size of 10 μm and more. The reason is that, similar to the case of adding other additives, when the inorganic filler 19 of less than 10 μm is contained in an amount of 1% or more, the inorganic filler 19 works as a core material, and the molded article is warped in molding.

As the inorganic filler 19, a glass fiber, a glass flake, a glass bead, a carbon fiber, mica, talc, calcium carbonate, magnesium hydroxide, boehmite or zinc oxide and the like can be used separately or plurally. In addition, two or more of these inorganic fillers 19 can be used in combination, and these inorganic fillers may be pretreated by a coupling agent such as an organosilane compound, an epoxy compound, an isocyanate compound, an organic titanate compound or an organoborane compound.

However, since the portion irradiated by the laser light may be at least 250° C. or higher, it is necessary to use the inorganic filler 19 in which the coupling agent has high heat resistance.

In the case where inorganic fillers 19 are used in combination, the adhesion between the resin component and the inorganic filler 19 may become a problem. In this case, in order to improve the adhesion, it is effective means not only to improve the material surface such as the surface modification of the inorganic filler 19, but also to irradiate multiple times by changing the irradiation energy of the laser light to one laminated part.

### (Regarding Lamination Molding Method)

### FIRST EXAMPLE

Since the temperature of the molding area is set near the melting point of the base resin powder 16, there is a problem that the molded article of the mixed resin powder 15 in the present embodiment is easily warped compared to the base resin powder 16 alone.

In such a case, by using the laser light with a low energy to mold a lower portion of the molded article in contact with a powder surface, and by using the laser light with a proper energy to mold a portion to be molded just above the lower portion, the influence of the set temperature of the molding area can be reduced.

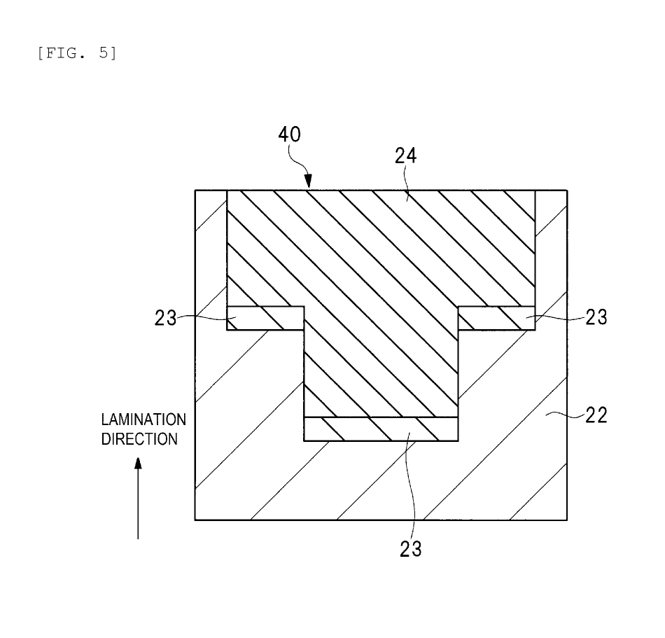

Specifically, as shown in FIG. 4, mixed resin powders 21 are disposed by the roller 1 (a step of “first resin powder disposition”), and thereafter sintering resin powders 21 are sintered by the laser light 4 with a low energy (a step of “low-energy laser sintering”). Then, the steps of “first resin powder disposition” and “low-energy laser sintering” are repeated multiple times, and thereby a first laser sintered portion 23 having a desired thickness and shape is molded.

Next, mixed resin powders 21 are disposed by the roller 1 (a step of “second resin powder disposition”), and thereafter sintering resin powders 21 are sintered by the laser light 4 with a proper energy (a step of “proper-energy laser sintering”). Then, the steps of “second resin powder disposition” and “proper-energy laser sintering” are repeated multiple times, and thereby a second laser sintered portion 24 having a desired thickness and shape is molded. Accordingly, the molded article is formed.

Examples of reducing the energy of the laser light include lowering a laser power, increasing a scan speed and increasing a laser irradiation pitch. However, when the energy of the laser light is reduced, only the surface of the mixed resin powders 21 is sintered, or a portion with a part not melted occurs. Therefore, voids are easy to occur, and the strength is decreased as the density decreases.

Therefore, in a case where the mixed resin powders 21 are used, it is desirable that the thickness of the lower portion of the molded article molded using the laser light with a low energy (the first laser sintered portion 23) is 0.2 mm or more and 0.5 mm or less, and thereafter, the energy of the laser light is increased to a proper energy. The portion molded using the laser light with a low energy has many voids and can have a low strength due to a low density thereof. However, the larger the thickness of the molded article is, the greater part thereof is constituted by the second laser sintered portion 24. Therefore, the influence of the low strength can be reduced.

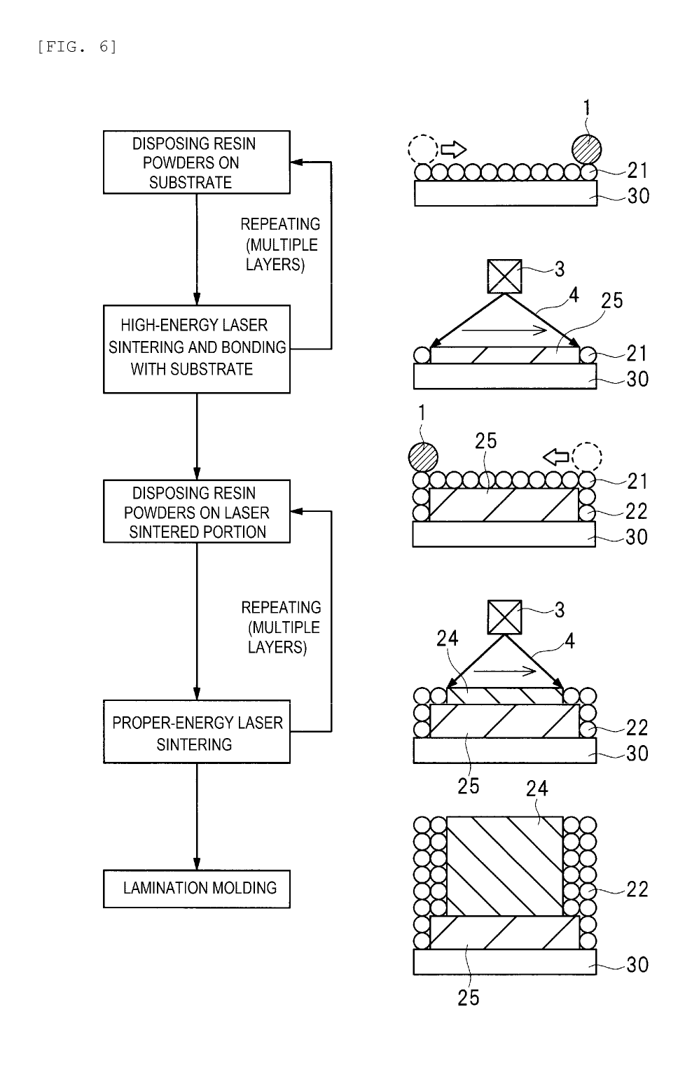

FIG. 5 is a cross-sectional view illustrating an example of the molded article molded by using the above lamination molding method.

In the resin molded article 40, the first laser sintered portion 23 is molded in contact with a powder surface in a lamination direction where a resin is laminated, and the second laser sintered portion 24 is molded just above the first laser sintered portion 23 in contact with the first laser sintered portion 23 in the lamination direction. The thickness of the first laser sintered portion 23 in the lamination direction is, for example, 0.5 mm.

The first laser sintered portion 23 has more holes compared to the second laser sintered portion 24. Therefore, a density of the first laser sintered portion 23 is lower than a density of the second laser sintered portion 24, and a surface roughness Ra of the first laser sintered portion 23 is larger than a surface roughness Ra of the second laser sintered portion 24.

### SECOND EXAMPLE

In a case of using the mixed resin powder 15 of the present embodiment, the powder lamination molding can be performed for a solid article such as a molded product of the same material, a molded product of different materials or a metal. In addition, a molded article can be configured by resin powders, but depending on the products, parts in which only apart is molded and which has complicated functionality may be configured.

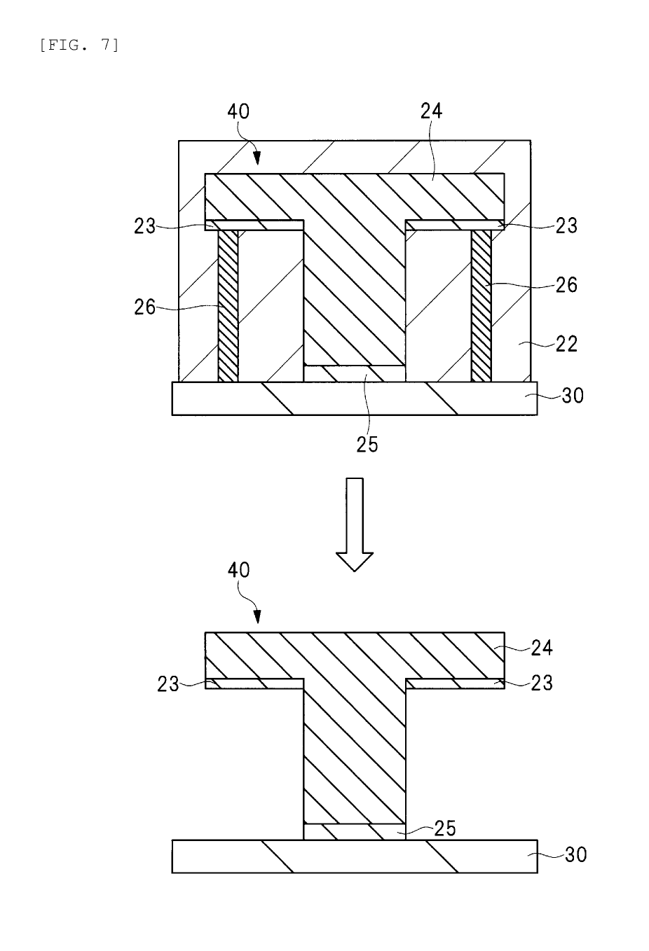

In such a case, as shown in FIG. 6, for example, it is preferable to prepared a solid article (a substrate) 30, and to perform molding using the mixed resin powder 15 thereon.

Specifically, mixed resin powders 21 are disposed on the solid article 30 by the roller 1 (a step of “disposing resin powders on the substrate”), and thereafter the mixed resin powders 21 are sintered by the laser light 4 with a high energy (a step of “high-energy laser sintering and bonding with the substrate”). Then, the steps of “disposing resin powders on the substrate” and “high-energy laser sintering and bonding with the substrate” are repeated multiple times, and thereby a third laser sintered portion 25 having a desired thickness and shape is molded.

Next, mixed resin powders 21 are disposed on the third laser sintered portion 25 by the roller 1 (a step of “disposing resin powders on the laser sintered portion”), and thereafter sintering resin powders 21 are sintered by the laser light 4 with a proper energy (a step of “proper-energy laser sintering”). Then, the steps of “disposing resin powders on the laser sintered portion” and “proper-energy laser irradiation” are repeated multiple times, and thereby a second laser sintered portion 24 having a desired thickness and shape is molded. Accordingly, the molded article is formed.

Particularly, in a case where the solid article 30 and the mixed resin powder 15 are not the same material, for example in the case where the solid article 30 is a molded product of different materials or a metal, it is necessary to irradiate the resin powder of several layers (for example, 0.1 mm to 0.3 mm) by the laser light 4 with a high energy, and to improve the adhesion of the solid article 30 and the mixed resin powder 15.

When the laser light 4 with a high energy is irradiated, the powder surface irradiated by the laser light 4 is easy to thermally decompose, but the strength of the powder surface is higher than the strength of the interface between the molded article (the third laser sintered portion 25) and the solid article 30, so that it is often not a big problem. Whether to irradiate the laser light 4 with a high energy can be confirmed according to a molecular weight of an adhesion portion of 0.3 mm or less, and can be judged by slightly lowering the molecular weight. In addition, not only the high-energy laser irradiation, but also multiple times of laser irradiation are effective in improving the adhesion.

In the solid article 30 such as a molded product of different materials or a metal, it is also effective means to improve the strength of the interface of the molded article and the solid article 30 by applying a surface treatment thereon in advance. Specifically, in a case of molding on the solid article 30, it is desirable to apply a plasma treatment, a UV ozone treatment or an excimer laser treatment on an upper surface of the solid article 30. In addition, in a case where the solid article 30 is a metal, it is also effective to impart a proper surface roughness (for example, having Ra of 1.0 μm to 7.0 μm) to the upper surface of the solid article 30, in addition to the above.

In addition, in a case where the molding is performed in a state where the temperature of the molding area is set to be lower than the crystallization temperature of the base resin powder 16, the recyclability of the mixed resin powder 15 is improved significantly, and there is a merit that an option of an additive relatively unstable to heat is also increased. Moreover, since the adhesion of the molded article and the non-sintered resin powders 22 buried in the molding area without being irradiated by the laser light is low, there is also a merit that the number of work steps for peeling the molded article and the non-sintered resin powders 22 can be reduced more significantly.

For the solid article 30 such as a molded product of the same material, a molded product of different materials or a metal, in the case of the powder lamination molding, since the solid article 30 for molding itself is a support, the mixed resin power 15 may contain many substances serving as a core material, depending on the structures.

In a case where the molding is performed in a state where the temperature of the molding area is lower than the crystallization temperature of the mixed resin powder 15, it is desirable that the rigidity of the solid article 30 is higher than the rigidity of the mixed resin powder 15. When the rigidity of the solid article 30 is low, the solid article 30 is warped due to the contractive force of the molded article, and even the molding cannot be performed.

In addition, for the solid article 30 such as a molded product of the same material, a molded product of different materials or a metal, in the case of performing the powder lamination molding, an extreme overhang portion may also be necessary in order to form a free shape.

In this case, as shown in FIG. 7, it is preferable to once form supports 26 with the mixed resin powder 15, and to remove the supports 26 finally. In addition, it is desirable to set the density of the supports 26 to be lower than the density of the resin molded article 40 by lowering the energy of the laser light, such that the supports 26 can be removed easily later.

As described above, the invention made by the present inventor has been described in detail based on the embodiments of the invention, but the invention is not limited to the above embodiments, and it goes without saying that various modifications can be made without departing from the gist thereof.

For example, although the embodiments are described separately, these embodiments are not unrelated to each other, and one is in a relationship of a modification of a part or the whole of the other. So far, although the laser powder lamination molding method is described, the invention may also be a method for melting, sintering, molding the resin powder by heating other than the laser. For example, a specific absorbing agent may be mixed with a resin powder and the mixture may be selectively heated with a light such as infrared rays absorbing the resin. Alternatively, a material absorbing light may be discharged selectively to the resin powder by an ink jet or the like, and similar to the roller, an infrared lamp or the like maybe physically moved and selectively heated. Further, it is also effective for a lamination molding method in which a molten resin is discharged from a nozzle and laminated.

### REFERENCE SIGN LIST

1 Roller (blade)
2 Laser light source
3 Galvanometer mirror
4 Laser light
5 Molding container
6 Storage container
7 Reflecting plate
8 Molding area
10, 11 Piston
15 Mixed resin powder
16 Base resin powder
17 High-melting-point resin powder
18 Lubricant
19 Inorganic filler
20 Resin powder
21 Mixed resin powder
22 Resin powder
23 First laser sintered portion (low-energy laser sintered portion)
24 Second laser sintered portion (proper-energy laser sintered portion)
25 Third laser sintered portion (high-energy laser sintered portion)
26 Support
30 Solid article
40 Resin molded article
50 Laser powder lamination molding device

1. A resin powder, which is a mixed resin powder used in powder lamination molding, comprising:
a thermoplastic first resin material having a first melting point; and
a thermoplastic second resin material having a second melting point higher than the first melting point.

2. The resin powder according to claim 1, wherein
an amount of the first resin material is more than an amount of the second resin material.

3. The resin powder according to claim 1, wherein
a particle size of the first resin material is larger than a particle size of the second resin material.

4. The resin powder according to claim 1, wherein
the particle size of the first resin material is 50 μm or more and 150 μm or less.

5. The resin powder according to claim 1, wherein
a Hausner ratio of the mixed resin powder is 1.34 or less at a room temperature.

6. The resin powder according to claim 1, wherein
the mixed resin powder contains 0.05 wt % or more and 1.0 wt % or less of an inorganic substance with an average primary particle diameter of 100 nm or less.

7. The resin powder according to claim 1, wherein
the mixed resin powder contains 5 wt % or more and 40 wt % or less of any one of an inorganic fiber, an inorganic flake or an inorganic bead, and
a size of the inorganic substance in a long axis direction is 200 μm or less.

8. The resin powder according to claim 1, wherein
the mixed resin powder contains a powder consisting of a copolymer.

9. The resin powder according to claim 1, wherein
the mixed resin powder starts crystallization in 300 seconds or more and starts semi-crystallization in 500 seconds or more in a temperature region of 200° C. or lower.

10. The resin powder according to claim 1, wherein
the first resin material is a polyester or polyamide having a melting point of 215° C. or lower.

11. A resin molded article, comprising: a first portion which is formed by powder lamination molding using a mixed resin powder, the mixed resin powder containing a thermoplastic first resin material having a first melting point, and a thermoplastic second resin material having a second melting point higher than the first melting point.

12. The resin molded article according to claim 11, comprising:
a second portion which is in contact with the first portion and is formed by the powder lamination molding using the mixed resin powder under the first portion, wherein
a density of the second portion is lower than a density of the first portion, and
a thickness of the second portion is 0.2 mm or more and 0.5 mm or less.

13. The resin molded article according to claim 11, wherein
the first portion is molded on a substrate,
a third portion is formed by the powder lamination molding between the first portion and the substrate using the mixed resin powder, and
a molecular weight of the third portion in a region from an upper surface of the substrate to 0.3 mm in a normal direction is lower than a molecular weight of the first portion.

14. A laser powder lamination molding device, comprising:
a roller for laying resin powders; and
a laser light source for irradiating a laser light to the laid resin powders, wherein
a resin molded article is molded by: a first step of sequentially repeating laying the resin powders by the roller and irradiating the laser light to the laid resin powders with a first energy, and
after the first step, a second step of sequentially repeating laying the resin powders by the roller and irradiating the laser light to the laid resin powders with a second energy which is different from the first energy.

15. The laser powder lamination molding device according to claim 14, wherein the resin powder is a mixed resin power containing:
a thermoplastic first resin material having a first melting point; and
a thermoplastic second resin material having a second melting point higher than the first melting point.
